(19) United States
(12) Patent Application Publication
(10) Pub. No.: US 2003/0208451 A1
(43) Pub. Date: Nov. 6, 2003

(54) Artificial neural systems with dynamic synapses

(76) Inventor: Jim-Shih Liaw, Arcadia, CA (US)

Correspondence Address: FISH & RICHARDSON, PC, 4350 LA JOLLA VILLAGE DRIVE, SUITE 500, SAN DIEGO, CA, 92122, US

(21) Appl. No.: 10/429,995

(22) Filed: May 5, 2003

Related U.S. Application Data
(60) Provisional application No. 60/377,410, filed on May 3, 2002.

(51) Int. Cl. G06G 7/00; G06F 15/18; G06E 1/00; G06E 3/00

(52) U.S. Cl. 706/8; 706/22

(57) ABSTRACT

Artificial neural network systems where each signal processing junction connected between signal processing elements is operable to, in response to a received impulse action potential, operate in at least one of three permitted manners: (1) producing one single corresponding impulse, (2) producing no corresponding impulse, and (3) producing two or more corresponding impulse. A preprocessing module may be used to filter the input signal to such networks. Various control mechanism may be implemented.

This application claims the benefit of U.S. Provisional Application No. 60/377,410 entitled “SIGNAL PROCESSING IN DYNAMIC SYNAPSE SYSTEMS” and filed May 3, 2002, the disclosure of which is incorporated herein by reference as part of this application.

### FIELD OF THE INVENTION

This application relates to information processing by artificial signal processors connected by artificial processing junctions, and more particularly, to artificial neural network systems formed of such signal processors and processing junctions.

### BACKGROUND

A biological nervous system has a complex network of neurons that receive and process external stimuli to produce, exchange, and store information. One dendrite (or axon) of a neuron and one axon (or dendrite) of another neuron are connected by a biological structure called a synapse. Neurons also make anatomical and functional connections with various kinds of effector cells such as muscle, gland, or sensory cells through another type of biological junctions called neuroeffector junctions. A neuron can emit a certain neurotransmitter in response to an action signal to control a connected effector cell so that the effector cell reacts accordingly in a desired way, e.g., contraction of a muscle tissue. The structure and operations of a biological neural network are extremely complex.

Various artificial neural systems have been developed to simulate some aspects of the biological neural systems and to perform complex data processing. One description of the operation of a general artificial neural network is as follows. An action potential originated by a presynaptic neuron generates synaptic potentials in a postsynaptic neuron. The postsynaptic neuron integrates these synaptic potentials to produce a summed potential. The postsynaptic neuron generates another action potential if the summed potential exceeds a threshold potential. This action potential then propagates through one or more links as presynaptic potentials for other neurons that are connected. Action potentials and synaptic potentials can form certain temporal patterns or sequences as trains of spikes. The temporal intervals between potential spikes carry a significant part of the information in a neural network. Another significant part of the information in an artificial neural network is the spatial patterns of neuronal activation. This is determined by the spatial distribution of the neuronal activation in the network.

### SUMMARY

This application includes systems and methods based on artificial neural networks using artificial dynamic synapses or signal processing junctions. Each processing junction is configured to dynamically adjust its response according to an incoming signal.

One exemplary artificial neural network system of this application includes a network of signal processing elements operating like neurons to process signals and a plurality of signal processing junctions distributed to interconnect the signal processing elements and to operate like synapses. Each signal processing junction is operable to process and is responsive to either or both of a non-impulse input signal and an input impulse signal from a neuron within said network. In response to a received impulse action potential, each signal processing junction is operable to operate in at least one of three permitted manners: (1) producing one single corresponding impulse, (2) producing no corresponding impulse, and (3) producing two or more corresponding impulses.

The above system may also include at least one signal path connected to one signal processing junction to send an external signal to the one signal processing junction. This signal processing junction is operable to respond to and process both the external signal and an input signal from a neuron in the network.

Another exemplary system of this application includes a network of signal processing elements operating like neurons to process signals and a plurality of signal processing junctions distributed to interconnect said signal processing elements, and a preprocessing module. The signal processing junctions operate like synapses. Each signal processing junction is operable to, in response to a received impulse action potential, operate in at least one of three permitted manners: (1) producing one single corresponding impulse, (2) producing no corresponding impulse, and (3) producing two or more corresponding impulse. The preprocessing module is operable to filter an input signal to the network and includes a plurality of filters of different characteristics operable to filter the input signal to produce filtered input signals to the network. One of the filters may be implemented by various filters including a bandpass filter, a highpass filter, a lowpass filter, a Gabor filter, a wavelet filter, a Fast Fourier Transform (FTT) filter, and a Linear Predictive Code filter. Two of the filters may be filters based on different filtering mechanisms, or filters based on the same filtering mechanism but have different spectral properties.

A method according to one example of this application includes filtering an input signal to produce multiple filtered input signals with different frequency characteristics, and feeding the filtered input signals into a network of signal processing elements operating like neurons to process signals and a plurality of signal processing junctions distributed to interconnect the signal processing elements.

These and other aspects and advantages of the present invention will become more apparent in light of the following detailed description, the accompanying drawings, and the appended claims.

### BRIEF DESCRIPTION OF THE DRAWINGS

FIG. 1 is a schematic illustration of a neural network formed by neurons and dynamic synapses.

FIG. 2A is a diagram showing a feedback connection to a dynamic synapse from a postsynaptic neuron.

FIG. 2B is a block diagram illustrating signal processing of a dynamic synapse with multiple internal synaptic processes.

FIG. 3A is a diagram showing a temporal pattern generated by a neuron to a dynamic synapse.

FIG. 3B is a chart showing two facilitative processes of different time scales in a synapse.

FIG. 3C is a chart showing the responses of two inhibitory dynamic processes in a synapse as a function of time.

FIG. 3D is a diagram illustrating the probability of release as a function of the temporal pattern of a spike train due to the interaction of synaptic processes of different time scales.

FIG. 3E is a diagram showing three dynamic synapses connected to a presynaptic neuron for transforming a temporal pattern of spike train into three different spike trains.

FIG. 4A is a simplified neural network having two neurons and four dynamic synapses based on the neural network of FIG. 1.

FIGS. 4B-4D show simulated output traces of the four dynamic synapses as a function of time under different responses of the synapses in a simplified network of FIG. 4A.

FIGS. 5A and 5B are charts respectively showing sample waveforms of the word “hot” spoken by two different speakers.

FIG. 5C shows the waveform of the cross-correlation between the waveforms for the word “hot” in FIGS. 5A and 5B.

FIG. 6A is schematic showing a neural network model with two layers of neurons for simulation.

FIGS. 6B, 6C, 6D, 6E, and 6F are charts respectively showing the cross-correlation functions of the output signals from the output neurons for the word “hot” in the neural network of FIG. 6A after training.

FIGS. 7A-7L are charts showing extraction of invariant features from other test words by using the neural network in FIG. 6A.

FIGS. 8A and 8B respectively show the output signals from four output neurons before and after training of each neuron to respond preferentially to a particular word spoken by different speakers.

FIG. 9A is a diagram showing one implementation of temporal signal processing using a neural network based on dynamic synapses.

FIG. 9B is a diagram showing one implementation of spatial signal processing using a neural network based on dynamic synapses.

FIG. 10 is a diagram showing one implementation of a neural network based on dynamic synapses for processing spatio-temporal information.

FIGS. 11, 12, and 13 show exemplary artificial neural network systems that use dynamic synapses and preprocessing module with filters.

FIGS. 14A, 14B, and 14C show exemplary artificial neural network systems that use dynamic synapses, preprocessing module with filters, and an optimization module for controlling the system operations.

FIG. 15 shows a part of an exemplary neural network with dynamic synapses that can respond to non-impulse input signals and to receive externals signals outside the neural network.

### DETAILED DESCRIPTION

The following description uses terms “neuron” and “signal processor”, “synapse” and “processing junction”, “neural network” and “network of signal processors” in a roughly synonymous sense. Biological terms “dendrite” and “axon” are also used to respectively represent an input terminal and an output terminal of a signal processor (i.e., a “neuron”). The dynamic synapses or processing junctions connected between neurons in an artificial neural network are described. System implementations of neural networks with such dynamic synapses or processing junctions are also described.

Notably, a system implementation may be a hardware implementation in which artificial devices or circuits are used as the neurons and dynamic synapses, or a software implementation where the neurons and dynamic synapses are software packets or modules. In a software implementation, a computer is programmed to execute various software routines, packages or modules for the neurons, dynamic synapses, and other signal processing devices or modules of the neural networks. These and other software instructions are stored in one or more memory devices either inside or connected to the computer. To interface with an external signal source such as receiving and processing speech from a person or an input image, receiver devices such as a microphone, camera, or signals processed by some filters, or data stored in files, etc. may be used. One or more analog-to-digital converters may be used to covert the input analog signals into digital signals that can be recognized and processed by the computer. An artificial neural network of this application may also be implemented in hybrid configuration with parts of the network implemented by hardware devices and other parts of the network implemented by software modules. Hence, each component of the neural networks of this application should be construed as either one or more hardware devices or elements, a software package or module, or a combination of both hardware and software.

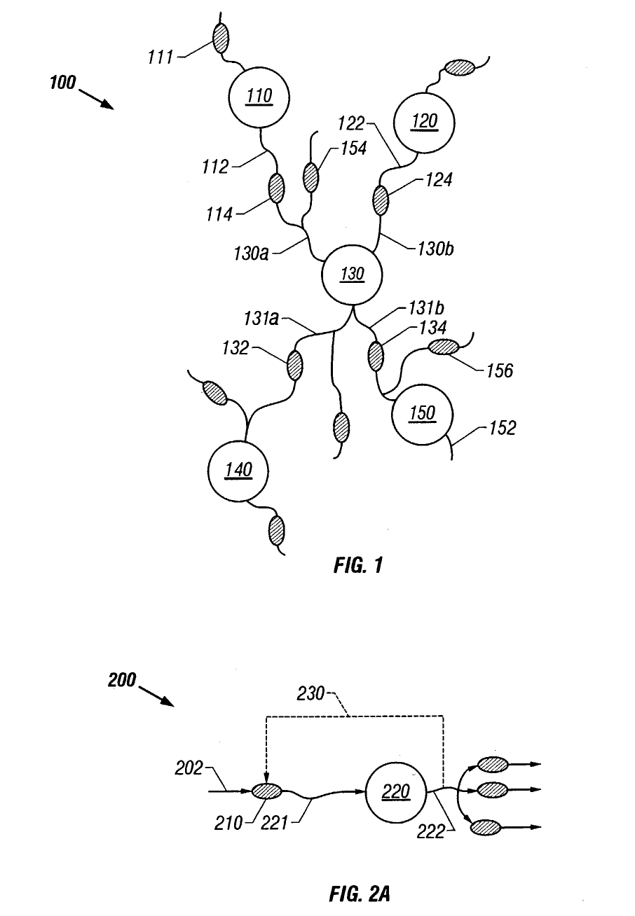

A neural network 100 based on dynamic synapses is schematically illustrated by FIG. 1. Large circles (e.g., 110, 120, etc.) represent neurons and small ovals (e.g., 114, 124, etc.) represent dynamic synapses that interconnect different neurons. Effector cells and respective neuroeffector junctions are not depicted here for sake of simplicity. The dynamic synapses each have the ability to continuously change an amount of response to a received signal according to a temporal pattern and magnitude variation of the received signal. This is different from many conventional models for neural networks in which synapses are static and each provide an essentially constant weighting factor to change the magnitude of a received signal.

Neurons 110 and 120 are connected to a neuron 130 by dynamic synapses 114 and 124 through axons 112 and 122, respectively. A signal emitted by the neuron 110, for example, is received and processed by the synapse 114 to produce a synaptic signal which causes a postsynaptic signal to the neuron via a dendrite 130a. The neuron 130 processes the received postsynaptic signals to produce an action potential and then sends the action potential downstream to other neurons such as 140, 150 via axon branches such as 131a, 131b and dynamic synapses such as 132, 134. Any two connected neurons in the network 100 may exchange information. Thus the neuron 130 may be connected to an axon 152 to receive signals from the neuron 150 via, e.g., a dynamic synapse 154.

Information is processed by neurons and dynamic synapses in the network 100 at multiple levels, including but not limited to, the synaptic level, the neuronal level, and the network level.

At the synaptic level, each dynamic synapse connected between two neurons (i.e., a presynaptic neuron and a postsynaptic neuron with respect to the synapse) also processes information based on a received signal from the presynaptic neuron, a feedback signal from the postsynaptic neuron, and one or more internal synaptic processes within the synapse. The internal synaptic processes of each synapse respond to variations in temporal pattern and/or magnitude of the presynaptic signal to produce synaptic signals with dynamically-varying temporal patterns and synaptic strengths. For example, the synaptic strength of a dynamic synapse can be continuously changed by the temporal pattern of an incoming signal train of spikes. In addition, different synapses are in general configured by variations in their internal synaptic processes to respond differently to the same presynaptic signal, thus producing different synaptic signals. This provides a specific way of transforming a temporal pattern of a signal train of spikes into a spatio-temporal pattern of synaptic events. Such a capability of pattern transformation at the synaptic level, in turn, gives rise to an exponential computational power at the neuronal level.

Another feature of the dynamic synapses is their ability for dynamic learning. Each synapse is connected to receive a feedback signal from its respective postsynaptic neuron such that the synaptic strength is dynamically adjusted in order to adapt to certain characteristics embedded in received presynaptic signals based on the output signals of the postsynaptic neuron. This produces appropriate transformation functions for different dynamic synapses so that the characteristics can be learned to perform a desired task such as recognizing a particular word spoken by different people with different accents.

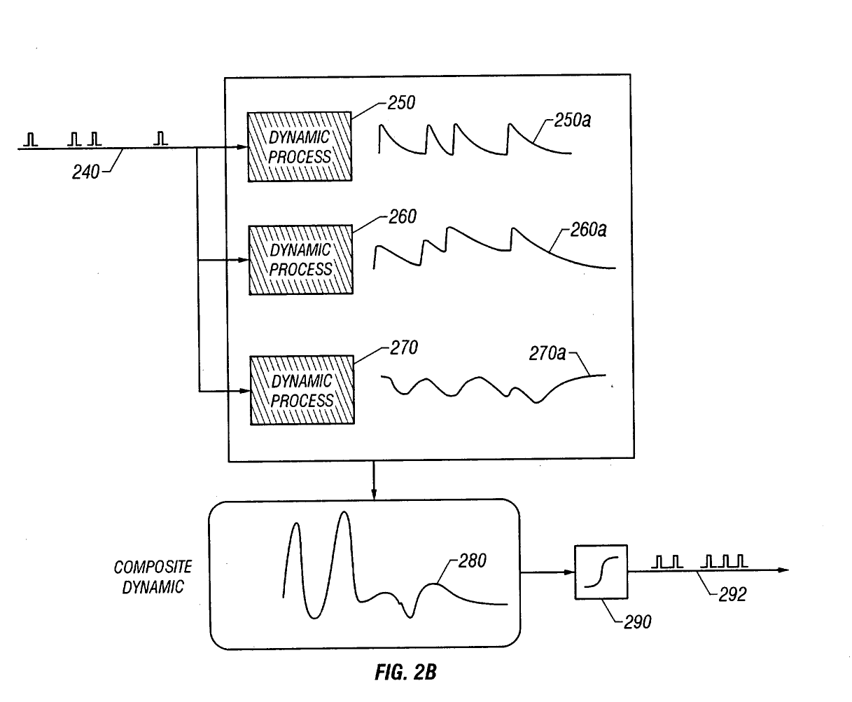

FIG. 2A is a diagram illustrating this dynamic learning in which a dynamic synapse 210 receives a feedback signal 230 from a postsynaptic neuron 220 to learn a feature in a presynaptic signal 202. The dynamic learning is in general implemented by using a group of neurons and dynamic synapses or the entire network 100 of FIG. 1.

Neurons in the network 100 of FIG. 1 are also configured to process signals. A neuron may be connected to receive signals from two or more dynamic synapses and/or to send an action potential to two or more dynamic synapses. Referring to FIG. 1, the neuron 130 is an example of such a neuron. The neuron 110 receives signals only from a synapse 111 and sends signals to the synapse 114. The neuron 150 receives signals from two dynamic synapses 134 and 156 and sends signals to the axon 152. However connected to other neurons, various neuron models may be used. See, for example, Chapter 2 in Bose and Liang, supra., and Anderson, “An introduction to neural networks,” Chapter 2, MIT (1997).

One widely-used simulation model for neurons is the integrator model. A neuron operates in two stages. First, postsynaptic signals from the dendrites of the neuron are added together, with individual synaptic contributions combining independently and adding algebraically, to produce a resultant activity level. In the second stage, the activity level is used as an input to a nonlinear function relating activity level (cell membrane potential) to output value (average output firing rate), thus generating a final output activity. An action potential is then accordingly generated. The integrator model may be simplified as a two-state neuron as the McCulloch-Pitts “integrate-and-fire” model in which a potential representing “high” is generated when the resultant activity level is higher than a critical threshold and a potential representing “low” is generated otherwise.

A real biological synapse usually includes different types of molecules that respond differently to a presynaptic signal. The dynamics of a particular synapse, therefore, is a combination of responses from all different molecules. A dynamic synapse may be configured to simulate the contributions from all dynamic processes corresponding to responses of different types of molecules. A specific implementation of the dynamic synapse may be modeled by the following equations:

$${P}_{i} ( t ) = {\sum }_{m} {K}_{i , m} ( t ) * {F}_{i , m} ( t ) , \qquad ( 1 )$$

where Pᵢ(t) is the potential for release (i.e., synaptic potential) from the ith dynamic synapse in response to a presynaptic signal, K_{i,m}(t) is the magnitude of the mth dynamic process in the ith synapse, and F_{i,m}(t) is the response function of the mth dynamic process.

The response F_{i,m}(t) is a function of the presynaptic signal, Aₚ(t), which is an action potential originated from a presynaptic neuron to which the dynamic synapse is connected. The magnitude of F_{i,m}(t) varies continuously with the temporal pattern of Aₚ(t). In certain applications, Aₚ(t) may be a train of spikes and the mth process can change the response F_{i,m}(t) from one spike to another. Aₚ(t) may also be the action potential generated by some other neuron, and one such example will be given later. Furthermore, F_{i,m}(t) may also have contributions from other signals such as the synaptic signal generated by dynamic synapse i itself, or contributions from synaptic signals produced by other synapses.

Since one dynamic process may be different form another, F_{i,m}(t) may have different waveforms and/or response time constants for different processes and the corresponding magnitude K_{i,m}(t) may also be different. For a dynamic process m with K_{i,m}(t)>0, the process is said to be excitatory, since it increases the potential of the postsynaptic signal. Conversely, a dynamic process m with K_{i,m}(t)<0 is said to be inhibitory.

In general, the behavior of a dynamic synapse is not limited to the characteristics of a biological synapse. For example, a dynamic synapse may have various internal processes. The dynamics of these internal processes may take different forms such as the speed of rise, decay or other aspects of the waveforms. A dynamic synapse may also have a response time faster than a biological synapse by using, for example, high-speed VLSI technologies. Furthermore, different dynamic synapses in a neural network or connected to a common neuron can have different numbers of internal synaptic processes.

The number of dynamic synapses associated with a neuron is determined by the network connectivity. In FIG. 1, for example, the neuron 130 as shown is connected to receive signals from three dynamic synapses 114, 154, and 124.

The release of a synaptic signal, Rᵢ(t), for the above dynamic synapse may be modeled in various forms. For example, the integrate models for neurons may be directly used or modified for the dynamic synapse. One simple model for the dynamic synapse is a two-state model similar to a neuron model proposed by McCulloch and Pitts:

$${R}_{i} ( t ) = \{ \begin{matrix}0 & if {P}_{i} ( t ) \leq {θ}_{i} , \\ f [ {P}_{i} ( t ) ] & if {P}_{i} ( t ) > {θ}_{i} ,\end{matrix} \qquad ( 2 )$$

where the value of Rᵢ(t) represents the occurrence of a synaptic event (i.e., release of neurotransmitter) when Rᵢ(t) is a non-zero value, f[Pᵢ(t)], or non-occurrence of a synaptic event when Rᵢ(t)=0 of and θᵢ is a threshold potential for the ith dynamic synapse. The synaptic signal Rᵢ(t) causes generation of a postsynaptic signal, Sᵢ(t), in a respective postsynaptic neuron by the dynamic synapse. For convenience, f[Pᵢ(t)] may be set to 1 so that the synaptic signal Rᵢ(t) is a binary train of spikes with 0s and 1s. This provides a means of coding information in a synaptic signal.

FIG. 2B is a block diagram illustrating signal processing of a dynamic synapse with multiple internal synaptic processes. The dynamic synapse receives an action potential 240 from a presynaptic neuron (not shown). Different internal synaptic processes 250, 260, and 270 are shown to have different time-varying magnitudes 250a, 260a, and 270a, respectively. The synapse combines the synaptic processes 250a, 260a, and 270a to generate a composite synaptic potential 280 which corresponds to the operation of Equation (1). A thresholding mechanism 290 of the synapse performs the operation of Equation (2) to produce a synaptic signal 292 of binary pulses.

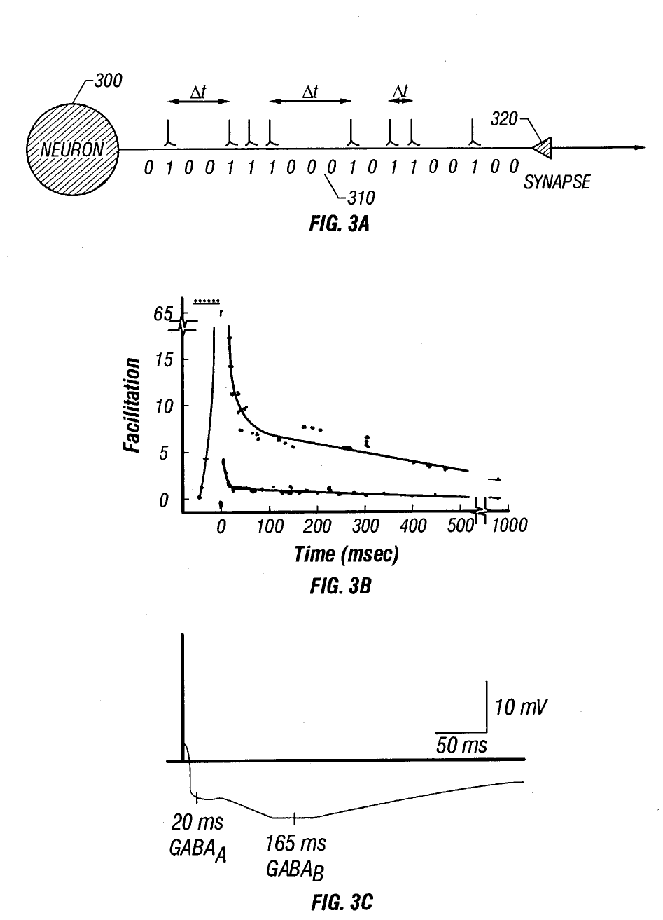

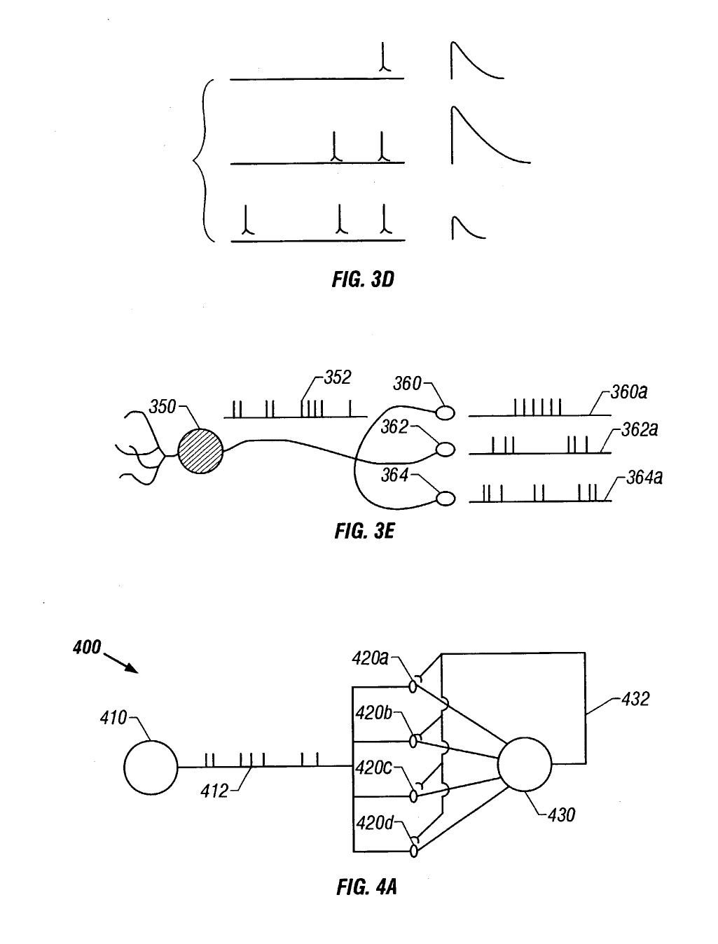

The probability of release of a synaptic signal Rᵢ(t) is determined by the dynamic interaction of one or more internal synaptic processes and the temporal pattern of the spike train of the presynaptic signal. FIG. 3A shows a presynaptic neuron 300 sending out a temporal pattern 310 (i.e., a train of spikes of action potentials) to a dynamic synapse 320a. The spike intervals affect the interaction of various synaptic processes.

FIG. 3B is a chart showing two facilitative processes of different time scales in a synapse. FIG. 3C shows two inhibitory dynamic processes (i.e., fast GABA_{A} and slow GABA_{B}). FIG. 3D shows the probability of release is a function of the temporal pattern of a spike train due to the interaction of synaptic processes of different time scales.

FIG. 3E further shows that three dynamic synapses 360, 362, 364 connected to a presynaptic neuron 350 transform a temporal spike train pattern 352 into three different spike trains 360a, 362a, and 364a to form a spatio-temporal pattern of discrete synaptic events of neurotransmitter release.

The capability of dynamically tuning synaptic strength as a function of the temporal pattern of neuronal activation gives rise to a significant representational and processing power at the synaptic level. Consider a neuron which is capable of firing at a maximum rate of 100 Hz during a time window of 100 ms. The temporal patterns that can be coded in this 10-bit spike train range from [00 . . . 0] to [11 . . . 1] to a total of 2¹⁰ patterns. Assuming that at most one release event may occur at a dynamic synapse per action potential, depending on the dynamics of the synaptic mechanisms, the number of the temporal patterns that can be coded by the release events at a dynamic synapse is 2¹⁰. For a neuron with 100 dynamic synapses, the total number of temporal patterns that can be generated is (2¹⁰)¹⁰⁰=2^{1,000}. The number would be even higher if more than one release event is allowed per action potential. The above number represents the theoretical maximum of the coding capacity of neurons with dynamic synapses and will be reduced due to factors such as noise or low release probability.

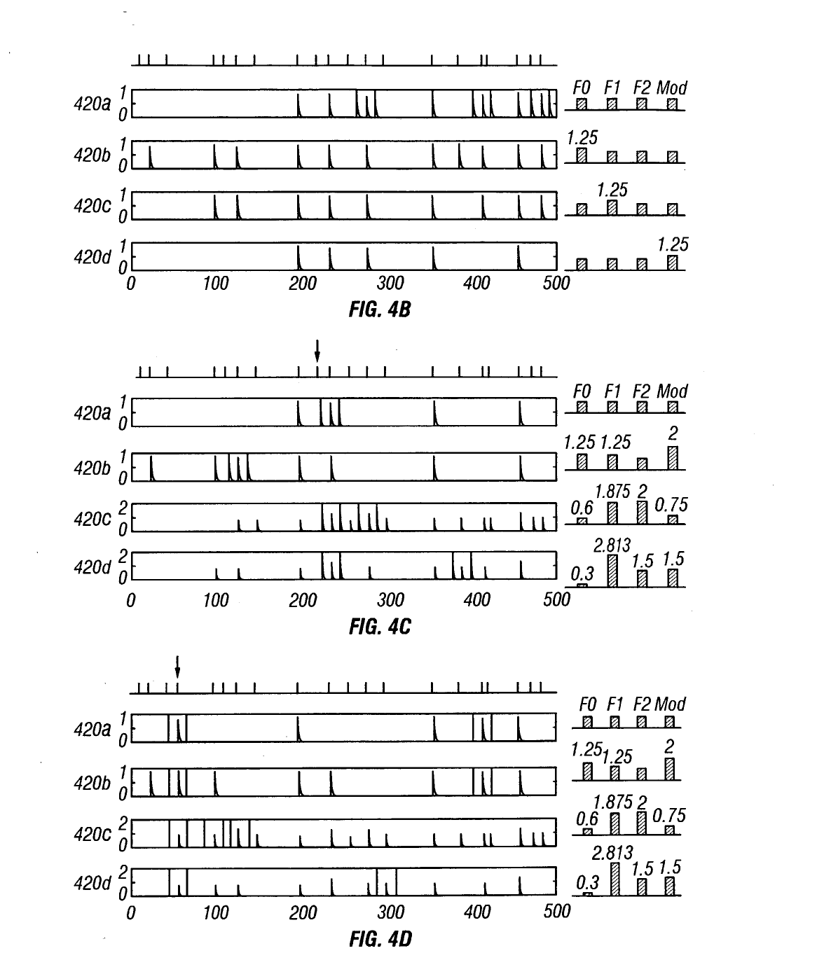

FIG. 4A shows an example of a simple neural network 400 having an excitatory neuron 410 and an inhibitory neuron 430 based on the system of FIG. 1 and the dynamic synapses of Equations (1) and (2). A total of four dynamic synapses 420a, 420b, 420c, and 420d are used to connect the neurons 410 and 430. The inhibitory neuron 430 sends a feedback modulation signal 432 to all four dynamic synapses.

The potential of release, Pᵢ(t), of ith dynamic synapse can be assumed to be a function of four processes: a rapid response, F₀, by the synapse to an action potential Aₚ from the neuron 410, first and second components of facilitation F₁ and F₂ within each dynamic synapse, and the feedback modulation Mod which is assumed to be inhibitory. Parameter values for these factors, as an example, are chosen to be consistent with time constants of facilitative and inhibitory processes governing the dynamics of hippocampal synaptic transmission in a study using nonlinear analytic procedures. See, Berger et al., “Nonlinear systems analysis of network properties of the hippocampal formation”, in “Neurocomputation and learning: foundations of adaptive networks,” edited by Moore and Gabriel, pp.283-352, MIT Press, Cambridge (1991) and “A biologically-based model of the functional properties of the hippocampus,” Neural Networks, Vol. 7, pp.1031-1064 (1994).

FIGS. 4B-4D show simulated output traces of the four dynamic synapses as a function of time under different responses of the synapses. In each figure, the top trace is the spike train 412 generated by the neuron 410. The bar chart on the right hand side represents the relative strength, i.e., K_{i,m} in Equation (1), of the four synaptic processes for each of the dynamic synapses. The numbers above the bars indicate the relative magnitudes with respect to the magnitudes of different processes used for the dynamic synapse 420a. For example, in FIG. 4B, the number 1.25 in bar chart for the response for F₁ in the synapse 420c (i.e., third row, second column) means that the magnitude of the contribution of the first component of facilitation for the synapse 420c is 25% greater than that for the synapse 420a. The bars without numbers thereabove indicate that the magnitude is the same as that of the dynamic synapse 420a. The boxes that encloses release events in FIGS. 4B and 4C are used to indicate the spikes that will disappear in the next figure using different response strengths for the synapses. For example, the rightmost spike in the response of the synapse 420a in FIG. 4B will not be seen in the corresponding trace in FIG. 4C. The boxes in FIG. 4D, on the other hand, indicate spikes that do not exist in FIG. 4C.

The specific functions used for the four synaptic processes in the simulation are as follows. The rapid response, F₀, to the action potential, Aₚ, is expressed as

$${τ}_{F0} \frac{ⅆ {F}_{0}}{ⅆ t} = - {F}_{0} + {k}_{{F}_{0}} {A}_{P} , \qquad ( 3 )$$

where τ_{F0}=0.5 ms is the time constant of F₀ for all dynamic synapses and k_{F0}=10.0 is for the synapse 420a and is scaled proportionally based on the bar charts in FIGS. 4B-4D for other synapses.

The time dependence of F₁ is

$${τ}_{f1} \frac{ⅆ {F}_{1}}{ⅆ t} = - {F}_{1} ( t ) + {k}_{f1\_ } {A}_{P} , \qquad ( 4 )$$

where T_{f1}=66.7 ms is the decay time constant of the first component of facilitation of all dynamic synapses and k_{f1}=0.16 for the synapse 420a.

The time dependence of F₂ is

$${τ}_{f2} \frac{ⅆ {F}_{2}}{ⅆ t} = - {F}_{2} ( t ) + {k}_{f2\_} {A}_{p} , \qquad ( 5 )$$

where τ_{f2}=300 ms is the decay time constant of the second component of facilitation of all dynamic synapses and k_{f2}=80.0 for the synapse 420a.

The inhibitory feedback modulation is

$${τ}_{Mod} \frac{ⅆ Mod}{ⅆ t} = - Mod + {k}_{Mod} \cdot {A}_{Inh} , \qquad ( 6 )$$

where A_{Inh} is the action potential generated by the neuron 430, τ_{Mod}=10 ms is the decay time constant of the feedback modulation of facilitation of all dynamic synapses, and k_{Mod}=−20.0 is for the synapse 420a.

Equations (3)-(6) are specific examples of F_{i,m}(t) in Equation (1). Accordingly, the potential of release at each synapse is a sum of all four contributions based on Equation (1):

P=F₀+F₁+F₂+Mod. (7)

A quanta Q (=1.0) of neurotransmitter is released if P is greater than a threshold θ_{R} (=1.0) and there is at least one quanta of neurotransmitter in each synapse available for release (i.e., the total amount of neurotransmitter, Nₜₒₜₐₗ, is greater than a quanta for release). The amount of the neurotransmitter at the synaptic cleft, N_{R}, is an example of Rᵢ(t) in Equation (2). Upon release of a quanta of neurotransmitter, N_{R} is reduced exponentially with time from the initial amount of Q:

$${N}_{R} = Q exp [ - \frac{t}{{τ}_{0}} ] , \qquad ( 8 )$$

where τ₀ is a time constant and is taken as 1.0 ms for simulation. After the release, the total amount of neurotransmitter is reduced by Q.

There is a continuous process for replenishing neurotransmitter within each synapse. This process can be simulated as follows:

$$\frac{ⅆ {N}_{Total}}{ⅆ t} = {τ}_{rp} ( {N}_{max} - {N}_{Total} ) , \qquad ( 9 )$$

where Nₘₐₓ is the maximum amount of available neurotransmitter and τᵣₚ is the rate of replenishing neurotransmitter, which are 3.2 and 0.3 ms⁻¹ in the simulation, respectively.

The synaptic signal, N_{R}, causes generation of a postsynaptic signal, S, in a respective postsynaptic neuron. The rate of change in the amplitude of the postsynaptic signal S in response to an event of neurotransmitter release is proportional to N_{R}:

$${τ}_{S} \frac{ⅆ S}{ⅆ t} = - S + {k}_{S\_} {N}_{R} , \qquad ( 10 )$$

where τ_{S} is the time constant of the postsynaptic signal and taken as 0.5 ms for simulation and k_{S} is a constant which is 0.5 for simulation. In general, a postsynaptic signal can be either excitatory (kₛ>0) or inhibitory (kₛ<0).

The two neurons 410 and 430 are modeled as “integrate-and-fire” units having a membrane potential, V, which is the sum of all synaptic potentials, and an action potential, Aₚ from a presynaptic neuron:

$${τ}_{V} \frac{ⅆ V}{ⅆ t} = - V + {\sum }_{i} {S}_{i} , \qquad ( 11 )$$

where τ_{V} is the time constant of V and is taken as 1.5 ms for simulation. The sum is taken over all internal synapse processes.

In the simulation, Aₚ=1 if V>θ_{R} which is 0.1 for the presynaptic neuron 410 and 0.02 for the postsynaptic neuron 430. It also assumed that the neuron is not in the refractory period (T_{ref}=2.0 ms), i.e., the neuron has not fired within the last T_{ref} of 2 ms.

Referring back to FIGS. 4B-4D, the parameter values for the synapse 420a is kept as constant in all simulations and is treated as a base for comparison with other dynamic synapses. In the first simulation of FIG. 4B, only one parameter is varied per terminal by an amount indicated by the respective bar chart. For example, the contribution of the current action potential (F₀) to the potential of release is increased by 25% for the synapse 420b, whereas the other three parameters remain the same as the synapse 420a. The results are as expected, namely, that an increase in either F₀, F₁, or F₂ leads to more release events, whereas increasing the magnitude of feedback inhibition reduces the number of release events.

The transformation function becomes more sophisticated when more than one synaptic mechanism undergoes changes as shown in FIG. 4C. First, although the parameters remain constant in the synapse 420a, fewer release events occur since an overall increase in the output from the other three synapses 420b, 420c, 420d causes an increased activation of the postsynaptic neuron. This in turn exerts greater inhibition of the dynamic synapses. This exemplifies how synaptic dynamics can be influenced by network dynamics. Second, the differences in the outputs from dynamic synapses are not merely in the number of release events, but also in their temporal patterns. For example, the second dynamic synapse (420b) responds more vigorously to the first half of the spike train and less to the second half, whereas the third terminal (420c) responds more to the second half. In other words, the transform of the spike train by these two dynamic synapses are qualitatively different.

Next, the response of dynamic synapses to different temporal patterns of action potentials is also investigated. This aspect has been tested by moving the ninth action potential in the spike train to a point about 20 ms following the third action potential (marked by arrows in FIGS. 4C and 4D). As shown in FIG. 4D, the output patterns of all dynamic synapses are different from the previous ones. There are some changes that are common to all terminals, yet some are specific to certain terminals only. Furthermore, due to the interaction of dynamics at the synaptic and network levels, removal of an action potential (the ninth in FIG. 4C) leads to a decrease of release events immediately, and an increase in release events at a later time.

It can be understood from the above description of the dynamic synapses that each processing junction unit (i.e., dynamic synapse) is operable to respond to a received impulse action potential in at least one of three permitted manners: (1) producing one single corresponding impulse, (2) producing no corresponding impulse, and (3) producing two or more corresponding impulses. FIGS. 4B-4D show different responses of the three dynamic synapses 420a, 420b, 420c, and 420d connected to receive a common signal 412 from the same neuron 410 and different responses to a received impulse by each dynamic synapse at different times. More specifically, a comparison between the top trace from the neuron 410 and the output responses of the dynamic synapses clearly shows that each dynamic synapse is operable to produce either one single corresponding impulse or no corresponding impulse for a received impulse from the neuron 410.

The dynamic synapse' feature of producing two or more corresponding impulses in response to a single input impulse is described in, e.g., the textual description related to Equations (1) through (11) and FIG. 3E. Referring to Equation (2), the response of each dynamic synapse may be represented by a two-state model based on a threshold potential. In one implementation, there are four different processes that can contribute to the response of a dynamic synapse. More specifically with respect to Equation (7), a quanta Q (=1.0) of neurotransmitter is released if P is greater than a threshold θ_{R} (=1.0) and there is at least one quanta of neurotransmitter in each synapse available for release (i.e., the total amount of neurotransmitter, Nₜₒₜₐₗ, is greater than a quanta for release) The amount of the neurotransmitter at the synaptic cleft, N_{R}, is an example of Ri(t) in Equation (2). Hence, each dynamic synapse is capable of producing two or more corresponding impulses when responding to a single received impulse. One of the consequences of this capability of producing two or more corresponding impulses when responding to a single received impulse is the significant increased coding capacity for an artificial neural network with such dynamic synapses.

To further illustrate the above dynamic features of the dynamic synapse, consider a simple example where a single input impulse (Action Potential, Ap) to a dynamic synapse can cause the synapse to produce multiple outputs. To simplify the mathematics, assume that that K_{f1}, K_{f2}, and K_{mod} in Equations (4), (5), and (6), respectively, to have the value of 0. It is also assumed that F1, F2, and Mod in Equations (4), (5), and (6), respectively, are initialized to be 0: F1(0)=0, F2(0)=0, and Mod(0)=0). Thus, F₁, F2, and Mod will be 0 at all time. Equation (7) would then be simplified to P=F₀, where the value of F₀ is calculated according to Equation (3). The output of the dynamic synapse can now be calculated as follows. Assuming Nₜₒₜₐₗ is initialized to be Nₘₐₓ in Euqation (9) and the value of Nₘₐₓ is set to 3.2, then the total amount of neurotransmitter is reduced by Q after the release. If the coeffecient K_{f0} in Equation (3) is set to a value sufficiently high, e.g., K_{f0}=100,000.0 instead of 10.0 as in the example given for FIG. 4 such that the value of F0 would stay greater than the threshold θ_{R} (=1.0) for a period of time.

Based on the above, consider a case where there is no input signal from time T(0) to T(n−1), and there is an input signal at T(n), and again there is no input signal from T(n+1) and beyond. Under this input condition, the output state of the dynamic synapse is given in the table below:

| | | | | | | | | | | |
|---|---|---|---|---|---|---|---|---|---|---|
| Time | 0 | 1 | . . . | n − 1 | n | n + 1 | n + 2 | n + 3 | n + 4 | . . . |
| Input | 0 | 0 | . . . | 0 | 1 | 0 | 0 | 0 | 0 | . . . |
| F₀ | 0 | 0 | . . . | 0 | >1 | >1 | >1 | >1 | >1 | . . . |
| P | 0 | 0 | . . . | 0 | >1 | >1 | >1 | >1 | >1 | . . . |
| Nₜₒₜₐₗ | 3.2 | 3.2 | . . . | 3.2 | 3.2 | 2.2 | 1.2 | 0.2 | 0.2 | . . . |
| Output | 0 | 0 | . . . | 0 | 1 | 1 | 1 | 0 | 0 | . . . |

Clearly, the dynamic synapse generates 3 output signals at times of T(n), T(n+1), and T(n+2) in response to a single input signal at the time of T(n).

One aspect of the invention is a dynamic learning ability of a neural network based on dynamic synapses. Referring back to the system 100 in FIG. 1, each dynamic synapse is configured according to a dynamic learning algorithm to modify the coefficient, i.e., K_{i,m}(t) in Equation (1), of each synaptic process in order to find an appropriate transformation function for a synapse by correlating the synaptic dynamics with the activity of the respective postsynaptic neurons. This allows each dynamic synapse to learn and to extract certain feature from the input signal that contribute to the recognition of a class of patterns.

In addition, the system 100 of FIG. 1 creates a set of features for identifying a class of signals during a learning and extracting process with one specific feature set for each individual class of signals.

One implementation of the dynamic learning algorithm for mth process of ith dynamic synapse can be expressed as the following equation:

K_{i,m}(t+Δt)=K_{i,m}(t)+αₘ_{_{—}}F_{i,m}(t)_{_{—}}A_{Pj}(t)−βₘ_{_{—}}[F_{i,m}(t)−F⁰_{i,m}], (12)

where Δt is the time elapse during a learning feedback, αₘ is a learning rate for the mth process, and Aₚⱼ (=1 or 0) indicates the occurrence (Aₚⱼ=1) or non-occurrence (Aₚⱼ=0) of an action potential of postsynaptic neuron j that is connected to the ith dynamic synapse, βₘ is a decay constant for the mth process and F₀_{i,m} is a constant for mth process of ith dynamic synapse. Equation (12) provides a feedback from a postsynaptic neuron to the dynamic synapse and allows a synapse to respond according to a correlation therebetween. This feedback is illustrated by a dashed line 230 directed from the postsynaptic neuron 220 to the dynamic synapse 210 in FIG. 2.

The above learning algorithm enhances a response by a dynamic synapse to patterns that occur persistently by varying the synaptic dynamics according to the correlation of the activation level of synaptic mechanisms and postsynaptic neuron. For a given noisy input signal, only the subpatterns that occur consistently during a learning process can survive and be detected by synaptic synapses.

This provides a highly dynamic picture of information processing in the neural network. At any state in a chain of information processing, the dynamic synapses of a neuron extract a multitude of statistically significant temporal features from an input spike train and distribute these temporal features to a set of postsynaptic neurons where the temporal features are combined to generate a set of spike trains for further processing. From the perspective of pattern recognition, each dynamic synapse learns to create a “feature set” for representing a particular component of the input signal. Since no assumptions are made regarding feature characteristics, each feature set is created on-line in a class-specific manner, i.e., each class of input signals is described by its own, optimal set of features.

This dynamic learning algorithm is broadly and generally applicable to pattern recognition of spatio-temporal signals. The criteria for modifying synaptic dynamics may vary according to the objectives of a particular signal processing task. In speech recognition, for example, it may be desirable to increase a correlation between the output patterns of the neural network between varying waveforms of the same word spoken by different speakers in a learning procedure. This reduces the variability of the speech signals. Thus, during presentation of the same words, the magnitude of excitatory synaptic processes is increased and the magnitude of inhibitory synaptic processes is decreased. Conversely, during presentation of different words, the magnitude of excitatory synaptic processes is decreased and the magnitude of inhibitory synaptic processes is increased.

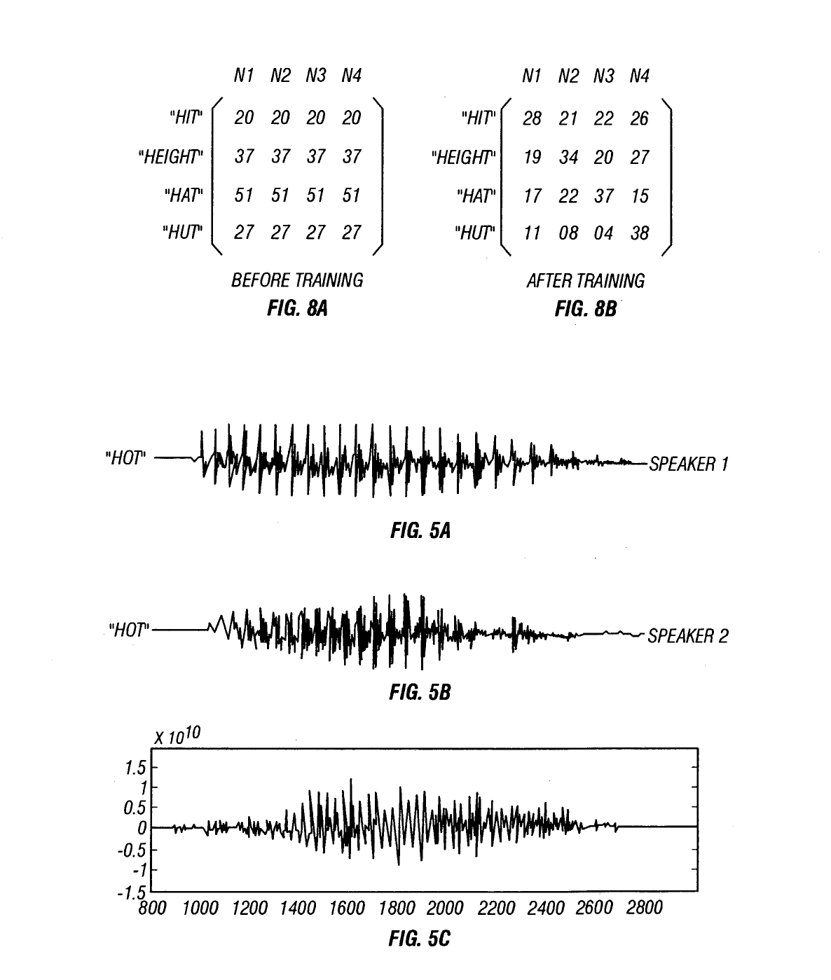

A speech waveform as an example for temporal patterns has been used to examine how well a neural network with dynamic synapses can extract invariants. Two well-known characteristics of a speech waveform are noise and variability. Sample waveforms of the word “hot” spoken by two different speakers are shown in FIGS. 5A and 5B, respectively. FIG. 5C shows the waveform of the cross-correlation between the waveforms in FIGS. 5A and 5B. The correlation indicates a high degree of variations in the waveforms of the word “hot” by the two speakers. The task includes extracting invariant features embedded in the waveforms that give rise to constant perception of the word “hot” and several other words of a standard “HVD” test (H-vowel-D, e.g., had, heard, hid). The test words are care, hair, key, heat, kit, hit, kite, height, cot, hot, cut, hut, spoken by two speakers in a typical research office with no special control of the surrounding noises (i.e., nothing beyond lowering the volume of a radio). The speech of the speakers is first recorded and digitized and then fed into a computer which is programmed to simulate a neural network with dynamic synapses.

The aim of the test is to recognize words spoken by multiple speakers by a neural network model with dynamic synapses. In order to test the coding capacity of dynamic synapses, two constraints are used in the simulation. First, the neural network is assumed to be small and simple. Second, no preprocessing of the speech waveforms is allowed.

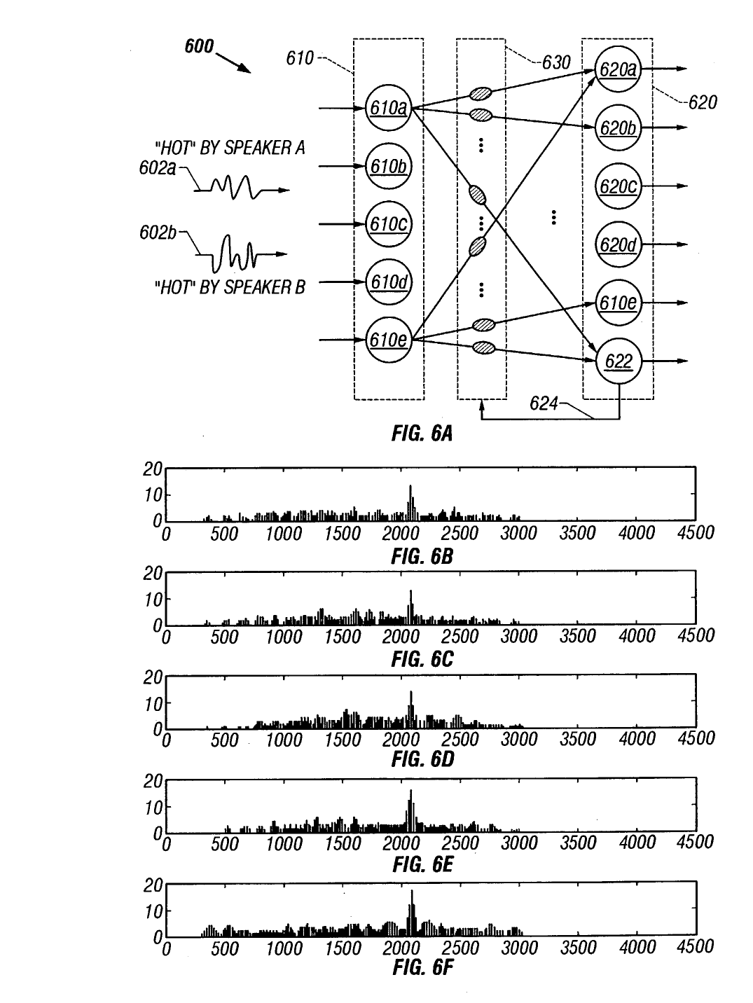

FIG. 6A is schematic showing a neural network model 600 with two layers of neurons for simulation. A first layer of neurons, 610, has 5 input neurons 610a, 610b, 610c, 610d, and 610e for receiving unprocessed noisy speech waveforms 602a and 602b from two different speakers. A second layer 620 of neurons 620a, 620b, 620c, 620d, 620e and 622 forms an output layer for producing output signals based on the input signals. Each input neuron in the first layer 610 is connected by 6 dynamic synapses to all of the neurons in the second layer 620 so there are a total of 30 dynamic synapses 630. The neuron 622 in the second layer 620 is an inhibitory interneuron and is connected to produce an inhibitory signal to each dynamic synapse as indicated by a feedback line 624. This inhibitory signal serves as the term “Aᵢₙₕ” in Equation (6). Each of the dynamic synapses 630 is also connected to receive a feedback from the output of a respective output neuron in the second layer 620 (not shown).

The dynamic synapses and neurons are simulated as previously described and the dynamic learning algorithm of Equation (12) is applied to each dynamic synapse. The speech waveforms are sampled at 8 KHz. The digitized amplitudes are fed to all the input neurons and are treated as excitatory postsynaptic potentials.

The network 600 is trained to increase the cross-correlation of the output patterns for the same words while reducing that for different words. During learning, the presentation of the speech waveforms is grouped into blocks in which the waveforms of the same word spoken by different speakers are presented to the network 600 for a total of four times. The network 600 is trained according to the following Hebbian and anti-Hebbian rules. Within a presentation block, the Hebbian rule is applied: if a postsynaptic neuron in the second layer 620 fires after the arrival of an action potential, the contribution of excitatory synaptic mechanisms is increased, while that of inhibitory mechanisms is decreased. If the postsynaptic neuron does not fire, then the excitatory mechanisms are decreased while the inhibitory mechanisms are increased. The magnitude of change is the product of a predefined learning rate and the current activation level of a particular synaptic mechanism. In this way, the responses to the temporal features that are common in the waveforms will be enhanced while that to the idiosyncratic features will be discouraged. When the presentation first switches to the next block of waveforms of a new word, the anti-Hebbian rule is applied by changing the sign of the learning rates αₘ and βₘ in Equation (12). This enhances the differences between the response to the current word and the response to the previous different word.

The results of training the neural network 600 are shown in FIGS. 6B, 6C, 6D, 6E, and 6F, which respectively correspond to the cross-correlation functions of the output signals from neurons 620a, 620b, 620c, 620d, and 620e for the word “hot”. For example, FIG. 6B shows the cross-correlation of the two output patterns by the neuron 620a in response to two waveforms of “hot” spoken by two different speakers. Compared to the correlation of the raw waveforms of the word “hot” in FIG. 5C which shows almost no correlation at all, each of the output neurons 620a-620e generates temporal patterns that are highly correlated for different input waveforms representing the same word spoken by different speakers. That is, given two radically different waveforms that nonetheless comprises a representation of the same word, the network 600 generates temporal patterns that are substantially identical.

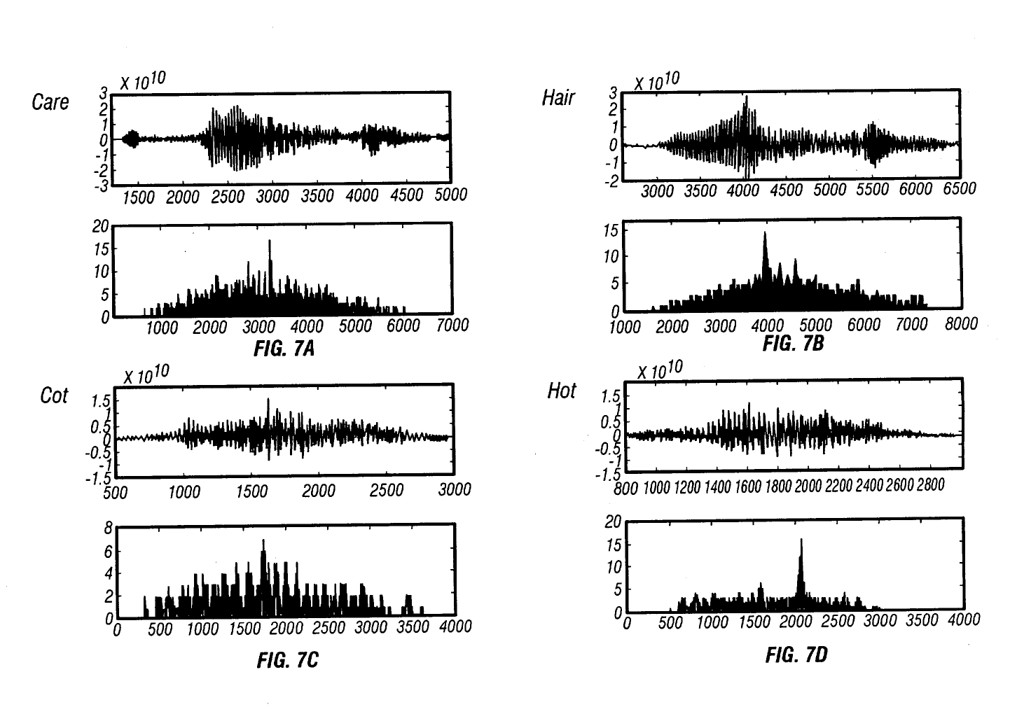

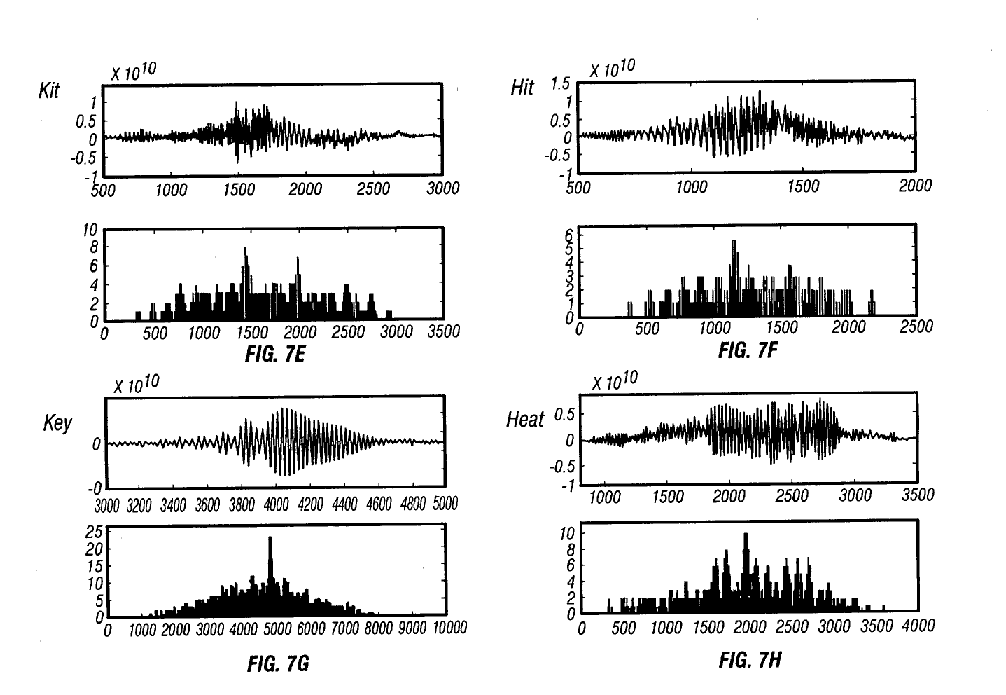

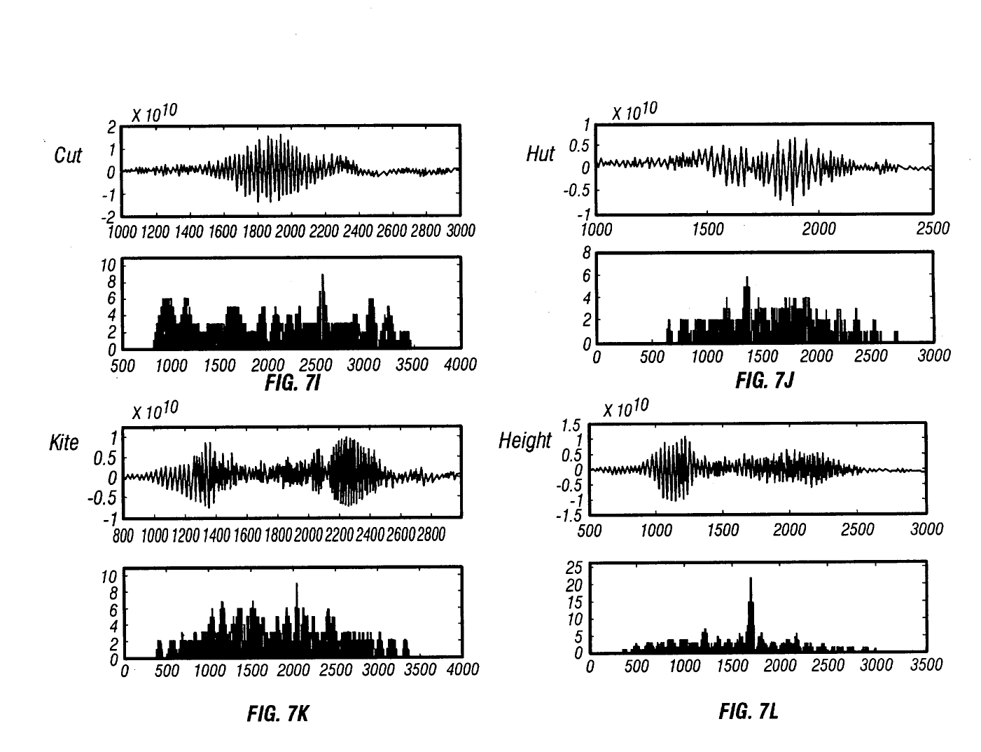

The extraction of invariant features from other test words by using the neural network 600 are shown in FIGS. 7A-7L. A significant increase in the cross-correlation of output patterns is obtained in all test cases.

The above training of a neural network by using the dynamic learning algorithm of Equation (12) can further enable a trained network to distinguish waveforms of different words. As an example, the neural network 600 of FIG. 6A produces poorly correlated output signals for different words after training.

A neural network based on dynamic synapses can also be trained in certain desired ways. A “supervised” learning, for example, may be implemented by training different neurons in a network to respond only to different features. Referring back to the simple network 600 of FIG. 6A, the output signals from neurons 602a (“N1”) , 602b (“N2”), 602c (“N3”) , and 602d (“N4”) may be assigned to different “target” words, for example, “hit”, “height”, “hot”, and “hut”, respectively. During learning, the Hebbian rule is applied to those dynamic synapses of 630 whose target words are present in the input signals whereas the anti-Hebbian rule is applied to all other dynamic synapses of 630 whose target words are absent in the input signals.

FIGS. 8A and 8B show the output signals from the neurons 602a (“N1”), 602b (“N2”), 602c (“N3”), and 602d (“N4”) before and after training of each neuron to respond preferentially to a particular word spoken by different speakers. Prior to training, the neurons respond identically to the same word. For example, a total of 20 spikes are produced by every one of the neurons in response to the word “hit” and 37 spikes in response to the word “height”, etc. as shown in FIG. 8A. After training the neurons 602a, 602b, 602c, and 602d to preferably respond to words “hit”, “height”, “hat”, and “hut”, respectively, each trained neuron learns to fire more spikes for its target word than other words. This is shown by the diagonal entries in FIG. 8B. For example, the second neuron 602b is trained to respond to word “height” and produces 34 spikes in presence of word “height” while producing less than 30 spikes for other words.

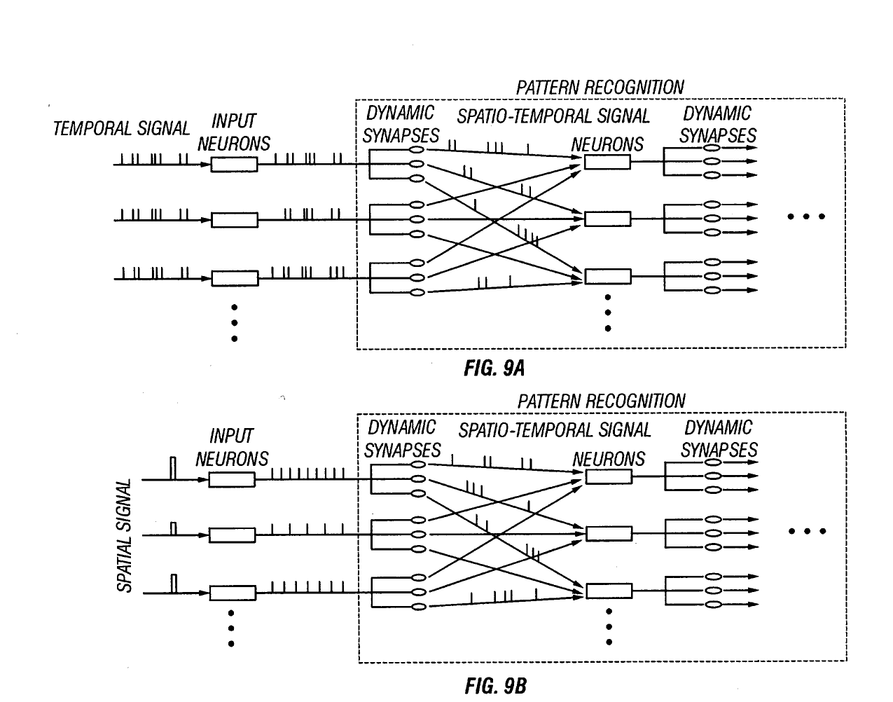

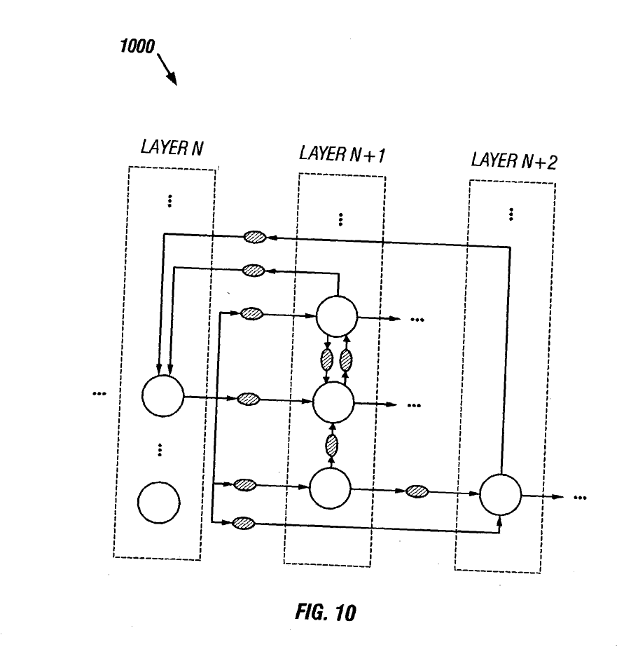

The above simulations of speech recognition are examples of temporal pattern recognition in the more general temporal signal processing where the input can be either continuous such as a speech waveform, or discrete such as time series data. FIG. 9A shows one implementation of temporal signal processing using a neural network based on dynamic synapses. All input neurons receive the same temporal signal. In response, each input neuron generates a sequence of action potentials (i.e., a spike train) which has a similar temporal characteristics to the input signal. For a given presynaptic spike train, the dynamic synapses generate an array of spatio-temporal patterns due to the variations in the synaptic dynamics across the dynamic synapses of a neuron. The temporal pattern recognition is achieved based on the internally-generated spatio-temporal signals.

A neural network based on dynamic synapses can also be configured to process spatial signals. FIG. 9B shows one implementation of spatial signal processing using a neural network based on dynamic synapses. Different input neurons at different locations in general receive input signals of different magnitudes. Each input neuron generates a sequence of action potentials with a frequency proportional the to the magnitude of a respective received input signal. A dynamic synapse connected to an input neuron produces a distinct temporal signal determined by particular dynamic processes embodied in the synapse in response to a presynaptic spike train. Hence, the combination of the dynamic synapses of the input neurons provide a spatio-temporal signal for subsequent pattern recognition procedures.

It is further contemplated that the techniques and configurations in FIGS. 9A and 9B can be combined to perform pattern recognition in one or more input signals having features with both spatial and temporal variations.

Under hardware implementations, the above described neural network models based on dynamic synapses may be implemented by devices having electronic components, optical components, and biochemical components. These components may produce dynamic processes different from the synaptic and neuronal processes in biological nervous systems. For example, a dynamic synapse or a neuron may be implemented by using RC circuits. This is indicated by Equations (3)-(11) which define typical responses of RC circuits. The time constants of such RC circuits may be set at values that different from the typical time constants in biological nervous systems. In addition, electronic sensors, optical sensors, and biochemical sensors may be used individually or in combination to receive and process temporal and/or spatial input stimuli.

It is noted that various modifications and enhancements may be made in the above described examples. For example, Equations (3)-(11) used in the examples have responses of RC circuits. Other types of responses may also be used such as a response in form of the α function: G(t)=α²te^{-αt}, where α is a constant and may be different for different synaptic processes. For another example, various different connecting configurations other than the examples shown in FIGS. 9A and 9B may be used for processing spatio-temporal information. FIG. 10 shows another implementation of a neural network based on dynamic synapses. In yet another example, the two-state model for the output signal of a dynamic synapse in Equation (2) may be modified to produce spikes of different magnitudes depending on the values of the potential for release.

The above dynamic synapses may be used in various artificial neural networks having a preprocessing stage that filters an input signal to be processed. Under this approach, the input signal is filtered in the frequency domain into multiple filtered input signals with different spectral properties. The filtered signals are then fed into the neural network with dynamic synapses in a dynamic manner for processing. A set of signal processing steps may be incorporated to receive the external signal, process it, and then feed it into the dynamic synapse system. The neural network with the dynamic synapses may be programmed or trained in specific ways to perform various tasks. In comparison, the neural network 600 shown in FIG. 6A directly receives the input signal without preprocessing filtering. The following sections describe signal processing, training, and optimization techniques in neural networks based on the preprocessing filters.

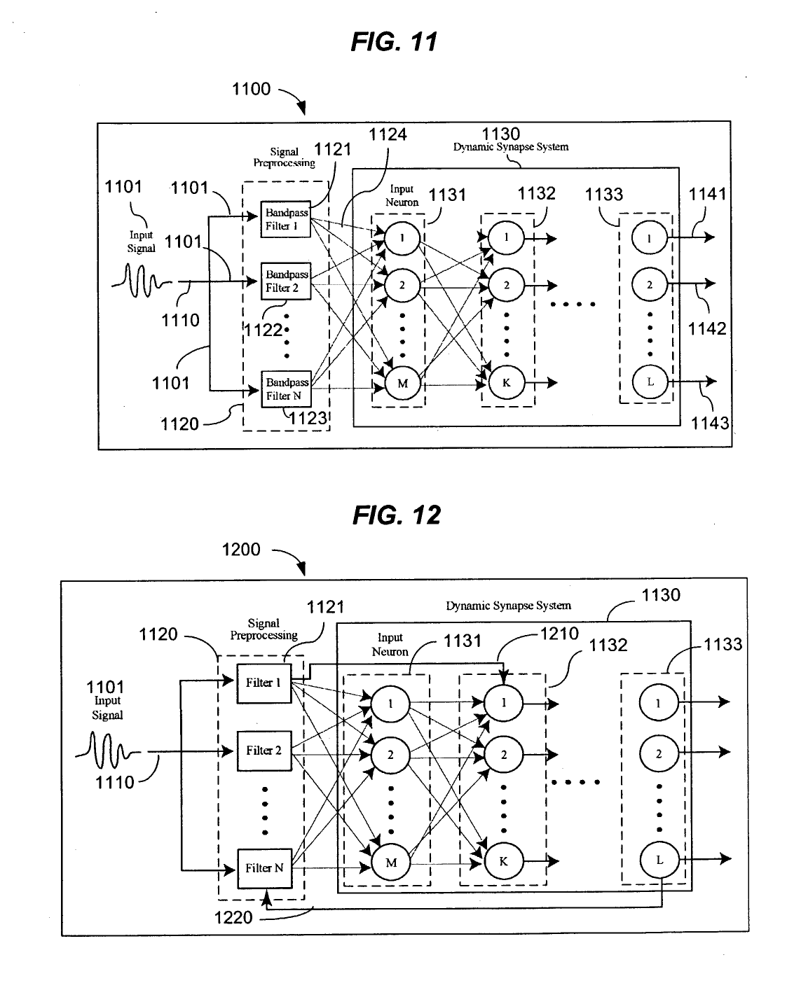

FIG. 11 shows an exemplary neural network system 1100 that has a dynamic synapse neural network 1130 and a preprocessing module 1120 with multiple signal filters (1121, 1122, . . . , and 1123). An input module or port 1110 receives an input signal 1101 and operates to partition and distribute the input signal 1101 to different signal filters within the preprocessing module 1120. Each input signal may be a temporal signal, a spatial signal, or a spatio-temporal signal.

The signal filters 1121, 1122, . . . , and 1123 may be implemented as a set of bandpass filters that separate the input signal into filtered signals 1124 in multiple bands of different frequency ranges. The filtered signal output from each filter may be fed into a selected group of neurons or all of the neurons in the dynamic synapse neural network 1130. As illustrated, the dynamic synapse neural network 1130 includes layers of neurons 1131, 1132, . . . , and 1133. In this specific example, the output of each filter is fed to each and every neuron in the input layer 1131. Alternatively, the input signals from the preprocessing module 1120 may be fed into one or two other layers of neurons. Notice that different layers of neurons may have either the same number of neurons (M=K= . . . =L) or different number of neurons (M#K= . . . =L). The dynamic synapses between the neurons may be connected as shown in, e.g., FIGS. 1, 2A, 4A, 6A, 9A, 9B, and 10, and are not illustrated here for simplicity. Although a single temporal input signal is illustrated in FIG. 11 for simplicity, the input signal 1101 may generally include spatial or spatio-temporal signals. Upon processing with the dynamic synapse neural network 1130, the output neurons in the output layer 1133 send out the processed output signals 1141, 1142, . . . , and 1143.

The signal filters 1121, 1122, . . . , and 1123 in the preprocessing module 1120 may also be other filters different from the bandpass filters. Examples of such filters include, but are not limited to, highpass filters at different cutoff frequencies, lowpass filters at different cutoff filters, Gabor filters, wavelet filters, Fast Fourier Transform (FTT) filters, Linear Predictive Code filters, or filters based on other filtering mechanisms, or a combination of two or more those and other filtering techniques.

In hardware implementation of the system 1100, different filters of different types, or filters of different filtering ranges of the same type, or a mixture of both may be installed in the system and connected through a switching control unit so that a desired group of filters may be selected from installed filters and be switched into operation to filter the input signal 1101. Under this design, the operating filters in the preprocessing module 1120 may be reconfigured as needed to achieve the desired signal processing in the dynamic synapse.

Software implementation of the preprocessing filtering may be achieved by providing in the computer system different software packages or modules that perform the desired signal filtering operations. Such software filters may be preinstalled in the computer system and are called or activated as needed. Alternatively, a software filter may be generated by the computer system when such a filter is needed. An analog signal such as a voice with a speech signal may be received by a microphone and converted into a digital signal before being filtered and processed by the software system shown in FIG. 11.

FIG. 12 shows another exemplary neural network system 1200 that further include additional signal paths such as a signal path 1210 from a filter 1221 in the preprocessing module 1120 to allow for an output of the filter 1221 to be fed to a selected neuron in a layer of neurons different from the input layer 1131 or a dynamic synapse in the dynamic synapse neural network 1130. In general, any signal filter in the module 1120 may be able to send its output to any neuron in the dynamic synapse neural network 1130. In addition, feedback paths 1220 may be implemented to allow for an output signal of any neuron in any layer to be fed back to any signal filter in the module 1120, such as the illustrated path 1220 between one or more neurons in the output layer 1133 and one or more signal filters in the preprocessing module 1120. The filters in the module 1120 may be different from one another and may also be dynamically changed when needed.

A dynamic synapse network system may also use a controller device based on some control signals to control the distribution of the input signal to the preprocessing module 1120. Likewise, the information flow between the signal preprocessing module 1120 and the dynamic synapse neural network 1130 may be controlled by controller devices based on their respective control signals.

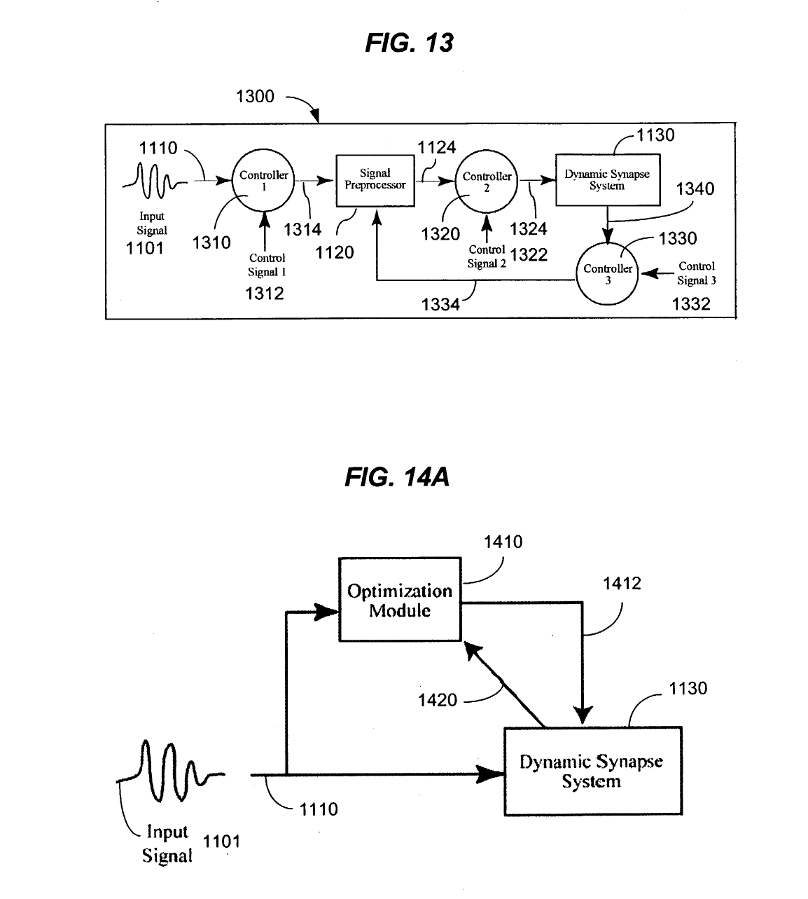

FIG. 13 shows an exemplary neural network system 1300 that includes controllers at selected locations to control input signals to the preprocessing module 1120 and the signals between the preprocessing module 1120 and the dynamic synapse neural network 1130. A controller 1310 (Controller 1) may be coupled in the input path of the input signal 1101 between the input port or module 1110 and the preprocessing module 1120 to respond to a first control signal 1312 to control the configuration of the preprocessing module 1120. For example, the controller 1310 may command the preprocessing module 1312 to select a certain set of filters from available filters in both hardware and software systems, and either or both available filters and newly-generated filters in software implementations under one or more operating conditions and to select a different set of filters in another operating condition. The controller 1310 may also operate to adjust frequency ranges of the filters such as the bandpass filters in the preprocessing module 1120.

Alternatively, the controller 1310 may be located out of the input signal path of the preprocessing module 1120 and be directly connected to the preprocessing module 1120 to adjust the configuration of the preprocessing module 1120 in response to the control signal 1312. Similarly, the control module 1320 may be out of the signal path between the dynamic synapse neural network 1130 and be directly connected to the dynamic synapse neural network 1130 to adjust the dynamic synapse neural network 1130.

A second controller 1320 (controller 2) may also be coupled in the signal path between the preprocessing module 1120 and the dynamic synapse neural network 1130 to configure certain aspect of the dynamic synapse neural network 1130 based on either or both of a control signal 1322 and the output 1124 of the signal preprocessing module 1120. For example, the connectivity pattern of the dynamic synapse neural network 1130, the time constants of the dynamic processes in dynamic synapses, operations of turning on or off certain unit or connectivity pathways of the dynamic synapse neural network 1310, etc. may be controlled by the controller 1320.

The system 1300 may further include a controller 1330 (Controller 3) to provide a feedback control between the dynamic synapse neural network 1130 and the preprocessing module 1120. The controller 1330 may be responsive to either or both of a control signal 1332 and an output 1340 of the dynamic synapse neural network 1130 to configure certain characteristics of the signal preprocessing module 1120, such as the types and number of filters, or the parameters of the tunable filters such as their operating frequency ranges, etc.

A dynamic learning algorithm may be used to monitor signals within a dynamic synapse neural network system, and optimize various parts of the system, and coordinate operations of various parts of the system. For example, the training of the dynamic synapse system may involve feedback signals from neurons within the dynamic synapse system to adjust the processes in other neurons and dynamic synapses in the dynamic synapse system. FIG. 2 illustrates one such scenario where a selected dynamic synapse is adjusted in response to an output of a neuron that receives output from the adjusted synapse.

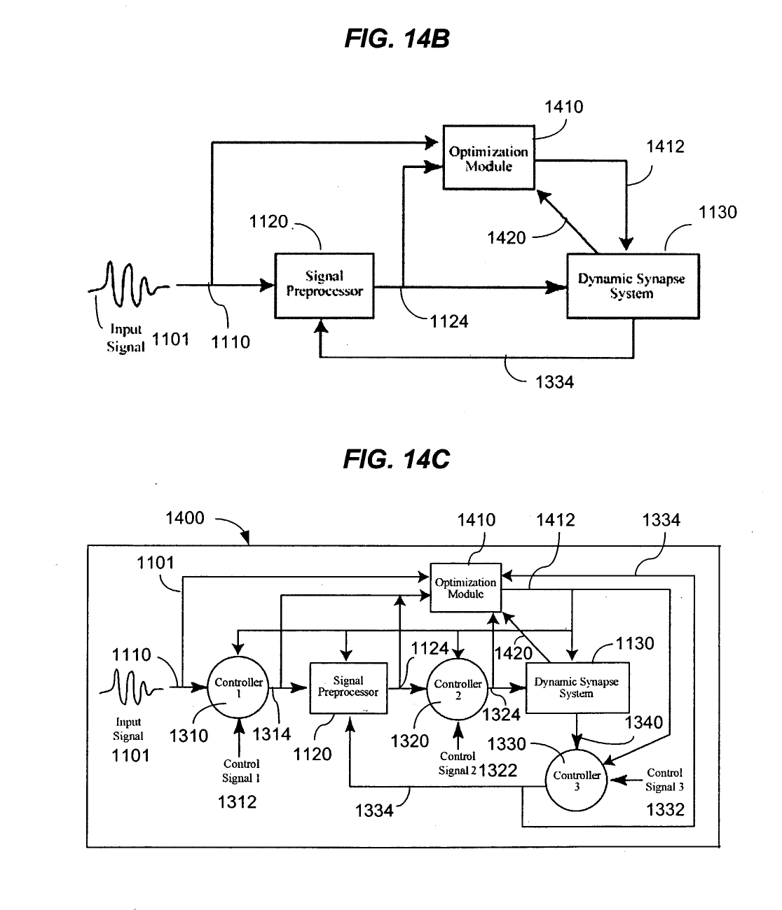

In addition, FIGS. 14A, 14B, and 14C show that an optimization module 1410 may be employed to receive external signals (e.g., the input 1101) and the output signals (e.g., the signal 1420) produced by the dynamic synapse system 1130 to control the operations of the neural network. The optimization module 1410 may send a signal 1412 to the dynamic synapse system 1130 to modify the processes and/or parameters in other neurons or synapses in the dynamic synapse system 1130 (FIG. 14A). In addition, the optimization module 1410 may receive signals from other components of the system and send signals to these components to adjust their processes and/or parameters, as illustrated in FIGS. 14B and C.

FIG. 14C illustrates an exemplary system 1400 that implements such an optimization module 1410. This optimization module 1410 receives multiple input signals from various parts to monitor the entire system. For example, the input signal 1101 is sampled by the optimization module 1410 to obtain information in the input signal 1101 to be processed by the system. The output signals of all modules or devices may also be sampled by the optimization module 1410, including the output signal 1314 of the first controller 1310, the output 1124 of the preprocessing module 1120, the output 1324 of the second controller 1320, an output 1420 of the dynamic synapse neural network 1130, and the output 1334 from the third controller 1332. In response to these sampled signals, the optimization module 1410 sends out multiple control signals 1412 to the devices and modules to adjust and optimize the system configuration and operations of the controlled devices and modules. As illustrated, the control signals 1412 produced by the optimization module 1410 include controls to the first, the second, and the third controllers 1310, 1320, and 1330, respectively, and controls to the preprocessing module 1120 and the dynamic synapse neural network 1130, respectively.

The above connections for the optimization module 1410 allows the optimization module 1410 to modify the processes and/or parameters in other neurons or synapses in the dynamic synapse neural network 1130, including the connectivity pattern, the number of layers, the number of neurons in each layer, the parameters of the neurons (time constants, threshold, etc.), the parameters of the dynamic synapses (the number of dynamic processes, their time constants, coefficients, thresholds, etc.) of the dynamic synapse neural network 1130. The optimization module 1410 may also adjust the parameters or the methods of the controllers, for example, changing the conditions for turning on or off a subunit of the dynamic synapse system, or the parameters for selecting a certain set of filters for the signal preprocessing unit. The optimization module 1410 may further be used to optimize the signal preprocessing module 1120. For example, it can modify the types and/or number of filters in the signal preprocessing module 1120, the parameters of individual filters (e.g., the frequency range of the bandpass filters, the functions, the number of levels, or the coefficients of wavelet filters, etc.). In general, the optimization module 1410 may be designed to incorporate various optimization methods such as Gradient Descent, Least Square Error, Back-Propagation, methods based on random search such as Genetic Algorithm, etc.

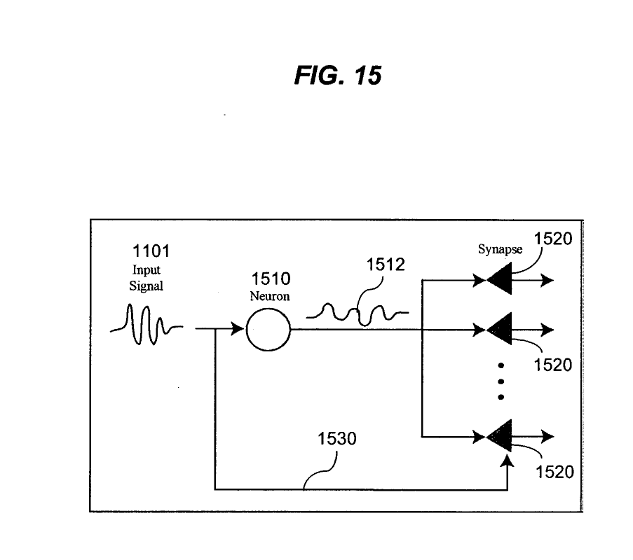

As described above, dynamic synapses in the above neural network 1130 may be configured to receive and respond to signals from neurons in the form of impulses. See, for example, action potential impulses in FIGS. 2B, 3A, 3D, 3E, 4, and in Equations (3) through (6). However, dynamic synapses may also be so configured such that non-impulse input signals, such as graded or wave-like signals, may also be processed by dynamic synapses. For example, the input to a dynamic synapse may be the membrane potential which is a continuous function as described in Equation (11) of a neuron, instead of the pulsed action potential. FIG. 15 illustrates dynamic synapses connected to a neuron 1510 to process non-impulse output signal 1512 from the neuron 1510.

In addition, a dynamic synapse may also be connected to receive signals external to the dynamic synapse neural network such as the direct input signal 1530 split off the input signal 1101 in FIG. 15. Such external signals 1530 may be temporal, spatial, or spatio-temporal signals. Furthermore, each synapse may receive different external signals.

In a more general context, the dynamic processes in a dynamic synapse may be described by the following equations:

P_{i,j}(t)=F(Iₖ(t)), (13)

where P_{i,j}(t) is dynamic process j in synapse i at time t, and F is a function of input signal Iₖ(t) at time t. The input signal Iₖ(t) may originate from sources internal (e.g., neurons or synapses) or external (e.g., microphone, camera, or signals processed by some filters, or data stored in files, etc.) to the dynamic synapse system. Note that some of the these signals have continuous values, as oppose to discrete impulses, that are fed to the dynamic synapse. The function F can be implemented in various ways. One example in which F is expressed as an ordinate differential equation is given below:

i,j(dP_{i,j}/dt)=−P_{i,j}+k_{i,j}*Iₖ, (14)

where τ_{i,j} is the time constant of P_{i,j}, and k_{i,j} is the co-efficient for weighting Iₖ for P_{i,j}. Other expressions of F may include the α function (G(t)=α²te^{-αt}, where α is a constant), sigmoid function, etc.

Therefore, a dynamic synapse of this application may be configured to respond to either or both of non-impulse input signals and impulse signals from a neuron within the neural network, and to an external signal generated outside of the neural network which may be a temporal, spatial, or spatio-temporal signal. When the input is an impulse signal, each dynamic synapse is operable to respond to a received impulse action potential in at least one of three permitted manners: (1) producing one single corresponding impulse, (2) producing no corresponding impulse, and (3) producing two or more corresponding impulses. Based on the above description, it can be appreciated that such a dynamic synapse may be used in dynamic neural networks with complex signal and control path configurations such as the example in FIG. 14 and may have versatile applications for various signal processing in either software or hardware artificial neural systems.

Only a few implementations are described to illustrate the features, operations, and advantages of the devices, systems, and methods of the present application. Various modifications, enhancements, and variations are possible and are within the scope of this application.

What is claimed is:

1. An artificial neural network system, comprising a network of signal processing elements operating like neurons to process signals and a plurality of signal processing junctions distributed to interconnect said signal processing elements, said signal processing junctions operating like synapses,
wherein each signal processing junction is operable to process and is responsive to either or both of a non-impulse input signal and an input impulse signal from a neuron within said network, and each signal processing junction is operable to respond to a received impulse action potential in at least one of three permitted manners: (1) producing one single corresponding impulse, (2) producing no corresponding impulse, and (3) producing two or more corresponding impulses.

2. The system as in claim 1, further comprising at least one signal path connected to one signal processing junction to send an external signal to said one signal processing junction, wherein said one signal processing junction is operable to respond to and process both said external signal and an input signal from a neuron in said network.

3. The system as in claim 2, wherein said external signal is one of a temporal signal, a spatial signal, and a spatio-temporal signal.

4. The system as in claim 1, further comprising a preprocessing module coupled to filter an input signal to said network, said preprocessing module comprising a plurality of filters of different characteristics operable to filter said input signal to produce filtered input signals to said network.

5. The system as in claim 4, wherein one of said filters is one of a bandpass filter, a highpass filter, a lowpass filter, a Gabor filter, a wavelet filter, a Fast Fourier Transform (FTT) filter, and a Linear Predictive Code filter.

6. The system as in claim 4, wherein two of said filters are filters based on different filtering mechanisms.

7. The system as in claim 4, wherein two of said filters are filters based on the same filtering mechanism but have different spectral properties.

8. The system as in claim 4, further comprising a first controller configured to control a filter configuration in said preprocessing module in response to a first control signal.

9. The system as in claim 8, further comprising:
a second controller configured to control said signal processing elements and said signal processing junctions in said network in response to at least one of an output from said preprocessing module and a second control signal; and
a third controller configured to control a filter configuration in said preprocessing module and said signal processing elements and said signal processing junctions in said network in response to at least one of an output from said network and a third control signal.

10. The system as in claim 9, further comprising an optimization module coupled to receive output signals from said first, said second, and said third controllers, and from said preprocessing module and said network, said optimization module operable to process said output signals to produce control signals to said first, said second, said third controllers, and said preprocessing module and said network.

11. The system as in claim 4, further comprising a second controller configured to control said signal processing elements and said signal processing junctions in said network in response to at least one of an output from said preprocessing module and a second control signal.

12. The system as in claim 4, further comprising a third controller configured to control a filter configuration in said preprocessing module and said signal processing elements and said signal processing junctions in said network in response to at least one of an output from said network and a third control signal.

13. The system as in claim 4, further comprising an optimization module coupled to receive an external signal generated outside said network, a first output signal from said preprocessing module, and a second output signal from said network, wherein said optimization module is operable to adjust a property of said network in response to said external signal, said first and said second output signals.

14. The system as in claim 1, further comprising an optimization module coupled to receive an external signal generated outside said network and an output signal from said network, wherein said optimization module is operable to adjust a property of said network in response to said external signal and said output signal.

15. An artificial neural network system, comprising:
a network of signal processing elements operating like neurons to process signals and a plurality of signal processing junctions distributed to interconnect said signal processing elements, said signal processing junctions operating like synapses, wherein each signal processing junction is operable to, in response to a received impulse action potential, operate in at least one of three permitted manners: (1) producing one single corresponding impulse, (2) producing no corresponding impulse, and (3) producing two or more corresponding impulses; and
a preprocessing module to filter an input signal to said network, said preprocessing module comprising a plurality of filters of different characteristics operable to filter said input signal to produce filtered input signals to said network.

16. The system as in claim 15, further comprising:
a first controller configured to control a filter configuration in said preprocessing module in response to a first control signal;
a second controller configured to control said signal processing elements and said signal processing junctions in said network in response to at least one of an output from said preprocessing module and a second control signal; and
a third controller configured to control a filter configuration in said preprocessing module and said signal processing elements and said signal processing junctions in said network in response to at least one of an output from said network and a third control signal.

17. The system as in claim 16, further comprising an optimization module coupled to receive output signals from said first, said second, and said third controllers, and from said preprocessing module and said network, said optimization module operable to process said output signals to produce control signals to said first, said second, said third controllers, and said preprocessing module and said network.

18. The system as in claim 15, further comprising an optimization module coupled to receive an external signal generated outside said network, a first output signal from said preprocessing module, and a second output signal from said network, wherein said optimization module is operable to adjust a property of said network in response to said external signal, said first and said second output signals.

19. A method for signal processing, comprising:
filtering an input signal to produce multiple filtered input signals with different frequency characteristics; and
feeding the filtered input signals into a network of signal processing elements operating like neurons to process signals and a plurality of signal processing junctions distributed to interconnect the signal processing elements, said signal processing junctions operating like synapses, wherein each signal processing junction is operable to, in response to a received impulse action potential, operate in at least one of three permitted manners: (1) producing one single corresponding impulse, (2) producing no corresponding impulse, and (3) producing two or more corresponding impulses.

20. The method as in claim 19, further comprising directing an external signal from a source outside the network to a signal processing junction and using the signal processing junction to process the external signal to produce an output to a neuron in the network.

21. The method as in claim 19, further comprising adjusting the filtering when processing different input signals.

22. The method as in claim 19, further comprising adjusting the filtering in response to an output of the network.

23. The method a sin claim 19, further comprising adjusting property of the network in response to an output of the network.
